(19) United States
(12) Patent Application Publication
(10) Pub. No.: US 2015/0194189 A1
(43) Pub. Date: Jul. 9, 2015

(54) SHEET OBJECT COVER

(71) Applicant: EVGA CORPORATION, NEW TAIPEI CITY (TW)

(72) Inventor: CHIN-YU KUO, New Taipei City (TW)

(21) Appl. No.: 14/307,500

(22) Filed: Jun. 18, 2014

(30) Foreign Application Priority Data
Jan. 3, 2014 (TW) 103200108

(51) Int. Cl. G11B 33/04

(52) U.S. Cl. CPC G11B 33/0494

(57) ABSTRACT

The present disclosure illustrates a sheet object cover which comprises a cover and a three dimensional structure. The cover comprises a first plate and a second plate. The three dimensional structure comprises a top plate and a bottom plate. The first opening places a sheet object. When the cover is in the closing status, the top plate and the bottom plate are folded to be accommodated inside the cover, so that the sheet object can be accommodated inside the cover. When the cover is in the opening status, the top plate and the bottom plate are pulled by the first plate and the second plate to enable the three dimensional structure to stand on the cover, so that the sheet object can stand on the three dimensional structure.

### CROSS-REFERENCE TO RELATED APPLICATION

This application claims the benefit of Taiwan Patent Application No. 103200108, filed on Jan. 3, 2014, in the Taiwan Intellectual Property Office, the disclosure of which is incorporated herein in its entirety by reference.

### BACKGROUND OF THE INVENTION

1. Field of the Invention

The present disclosure is related to a sheet object cover, more particularly, to a cover capable of accommodating the sheet object and exhibiting the sheet object in a standing position.

2. Description of the Related Art

Generally, the devices for collecting the compact disc (CD) include an acrylic rigid cassette, an envelope cover and a rigid paper cassette, and main purpose of these devices is to wrap and accommodate the compact disc. Generally, the acrylic rigid cassette is made of transparent plastic, and one side of the acrylic rigid cassette is usually provided with a front cover of the CD for easy identification of content of CD. The acrylic rigid cassette has better protection for the CD. Alternatively, the CD can just be accommodated directly inside the envelope cover or the rigid paper cassette which have advantages of low cost and saving space.

However, the acrylic rigid cassette has drawbacks of high cost and occupying mush space while user collects a lot of acrylic rigid cassettes. The envelope cover and the rigid paper cassette have said advantages, but when an exhibition CD is saved in the envelope cover and the rigid paper cassette, it is not easy to show such exhibition CD.

### SUMMARY OF THE INVENTION

To solve above problems in the prior art, one of objectives of the present disclosure is to provide a sheet object cover which accommodates a CD by sheet wrapping, so that easy CD collection with low cost can be achieved.

Another objective of the present disclosure is to provide a sheet object cover, when this sheet object cover is opened, a sheet object within the cover such as CD and picture, can be exhibited directly by an unfolded three dimensional structure of the sheet object cover.

An exemplary embodiment of the present disclosure provides a sheet object cover which comprises a cover and a three dimensional structure. The cover comprises a first plate and a second plate which are positioned in an opening status or a closing status. The three dimensional structure comprises a top plate and a bottom plate. The top plate comprises a first opening, a first crease and a plurality of first binding layers. The bottom plate comprises a second crease and a plurality of second binding layers. The first binding layers are bound with the first plate and the second plate, respectively. The first opening is configured for placing the sheet object. The second binding layers are bound with the first plate and the second plate, respectively. When the cover is positioned in the closing status, the top plate and the bottom plate are folded along the first crease and the second crease to be accommodated inside the cover, so that the sheet object can be accommodated inside the cover. When the cover is positioned in the opening status, the top plate and the bottom plate are pulled by the first plate and the second plate to enable the three dimensional structure to stand on the cover, so that the sheet object can stand on the three dimensional structure.

Preferably, the first plate and the second plate are formed by doubling up a first folded paper.

Preferably, the top plate and the bottom plate are formed by doubling up a second folded paper.

Preferably, an area of the first plate is just larger than an area of the second plate a little, and a side edge of the first plate comprises a folded surface, and when the cover is closed, the folded surface is inserted into an inserted part of the second plate to fix the closed cover.

Preferably, the bottom plate further comprises a second opening to place the sheet object, and length of the second opening is just shorter than length of the first opening a little.

Preferably, the sheet object is inserted the first opening and the second opening to stand stably in the three dimensional structure.

Preferably, the first opening or the second opening comprises a slit opening.

Preferably, the sheet object comprises a CD or photograph.

Preferably, when the cover is opened, the three dimensional structure enables the sheet object to stand vertically by the sheet tension of the first plate and the second plate.

### BRIEF DESCRIPTION OF THE DRAWINGS

The detailed structure, operating principle and effects of the present disclosure will now be described in more details hereinafter with reference to the accompanying drawings that show various embodiments of the disclosure as follows.

FIG. 1 is a block diagram of a sheet object cover according to the present disclosure.

FIG. 2 is a schematic view of an embodiment of the sheet object cover according to the present disclosure.

FIG. 3 is a first schematic view of another embodiment of the sheet object cover according to the present disclosure.

FIG. 4 is a second schematic view of another embodiment of the sheet object cover according to the present disclosure.

### DETAILED DESCRIPTION OF THE PREFERRED EMBODIMENTS

Reference will now be made in detail to the exemplary embodiments of the present disclosure, examples of which are illustrated in the accompanying drawings. Therefore, it is to be understood that the foregoing is illustrative of exemplary embodiments and is not to be construed as limited to the specific embodiments disclosed, and that modifications to the disclosed exemplary embodiments, as well as other exemplary embodiments, are intended to be included within the scope of the appended claims. These embodiments are provided so that this disclosure will be thorough and complete, and will fully convey the inventive concept to those skilled in the art. The relative proportions and ratios of elements in the drawings may be exaggerated or diminished in size for the sake of clarity and convenience in the drawings, and such arbitrary proportions are only illustrative and not limiting in any way. The same reference numbers are used in the drawings and the description to refer to the same or like parts.

It will be understood that, although the terms ‘first’, ‘second’, ‘third’, etc., may be used herein to describe various elements, these elements should not be limited by these terms. The terms are used only for the purpose of distinguishing one component from another component. Thus, a first element discussed below could be termed a second element without departing from the teachings of embodiments. As used herein, the term “or” includes any and all combinations of one or more of the associated listed items.

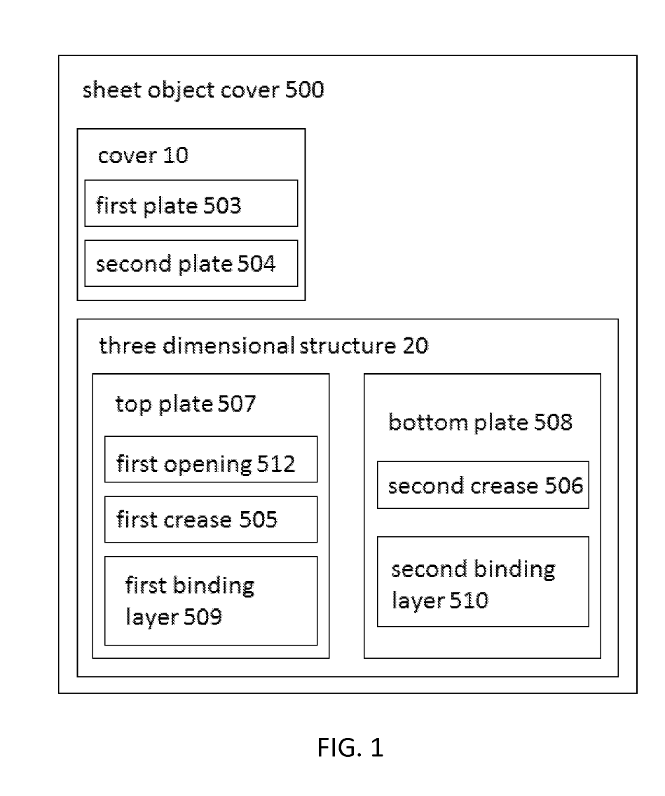

Please refer to FIG. 1 which is a block diagram of a sheet object cover according to the present disclosure. As shown in FIG. 1, the sheet object cover 500 is adapted for collecting or exhibiting a sheet object 511. The sheet object 511 comprises a cover 10 and a three dimensional structure 20. Preferably, the cover 10 can be a paper material. The cover 10 comprises a first plate 503 and a second plate 504, and the cover 10 has an opening status 514 and a closing status 515 which are not shown in FIG. 1.

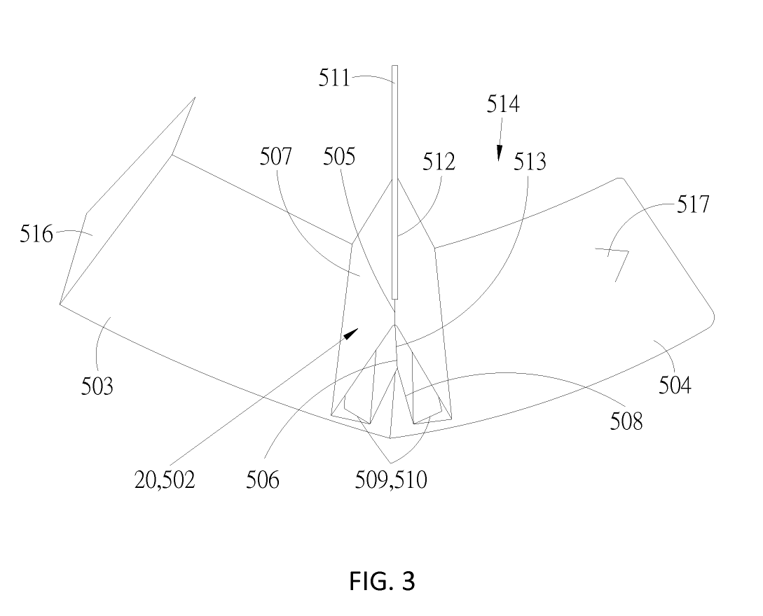

The three dimensional structure 20 may comprise a top plate 507 and a bottom plate 508. In this embodiment, the media for forming the top plate 507 and the bottom plate 508 may be a sheet. The top plate 507 may comprise a first opening 512, a first crease 505 and a plurality of first binding layers 509. The plurality of first binding layers 509 of the top plate 507 are bound to the first plate 503 and the second plate 504. The bottom plate 508 may comprise a second crease 506 and a plurality of second binding layers 510, and the plurality of second binding layers 510 of the bottom plate 508 are bound to the first plate 503 and the second plate 504, respectively. The top plate 507 of the first opening 512 is configured for placing a sheet object 511 which is shown in FIG. 3. In this embodiment, the first opening 512 comprises a slit opening, and the sheet object 511 may comprise a CD or a photograph, but the present disclosure is not limited thereto.

In detail, when the cover 10 is positioned in the closing status 515, the top plate 507 and the bottom plate 508 are folded along the first crease 505 and the second crease 506 respectively to be accommodated inside the cover 10, so that the sheet object 511 can be accommodated inside the cover 10 correspondingly. When the cover 10 is positioned in the opening status 514, the top plate 507 and the bottom plate 508 are pulled by the first plate 503 and the second plate 504 to enable the three dimensional structure 20 to stand on the cover 10, so that the sheet object 511 can be supported to stand vertically on the three dimensional structure 20.

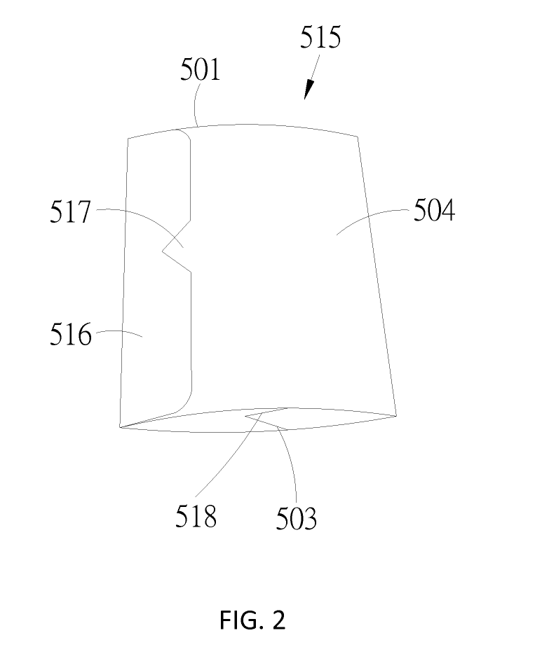

Please refer to FIG. 2 which is a schematic view of an embodiment of the sheet object cover according to the present disclosure. As shown in FIG. 2, the first plate 503 and the second plate 504 of the cover 10 may be formed by doubling up single first folded paper 501. Preferably, an area of the first plate 503 is just larger than an area of the second plate 504 a little. A side edge of the first plate 503 comprises a folded surface 516, and when the cover 10 is closed, the folded surface 516 is inserted into an inserted part 517 of the second plate 504 to fix the closed cover 10. It is noted that the area of the second plate 504 can be designed to enable an accommodating part 518 to be formed when the second plate 504 overlays the first plate 503 and the cover 10 is closed. The accommodating part 518 functions as a buffer to prevent the sheet object 511 from being damaged due to friction between the cover 10 and the sheet object 511. As the sheet object 511 is a CD, buffering function of the accommodating part 518 is very important.

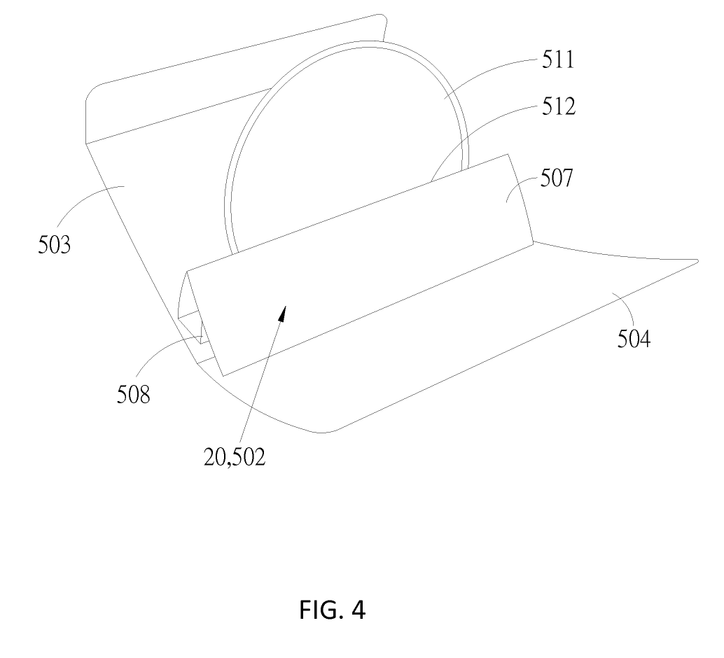

Please refer to FIG. 3 and FIG. 4 which are a first schematic view and a second schematic view of another embodiment of the sheet object cover according to the present disclosure. As shown in FIG. 3 and FIG. 4, the top plate 507 and the bottom plate 508 of the three dimensional structure 20 may be integrally formed. For example, the top plate 507 and the bottom plate 508 may be formed by doubling up a second folded paper 502. The top plate 507 and the bottom plate 508 are bound to the first plate 503 and the second plate 504 by the first binding layer 509 and the second binding layer 510. In implementation, the bottom plate 508 may further comprise a second opening 513 to place the sheet object 511, and length of second opening 513 may be just shorter than length of the first opening 512 a little. The first opening 512 or the second opening 513 may comprise a slit opening.

When the sheet object cover 500 is positioned in the opening status 514, the top plate 507 and the bottom plate 508 are pulled by the first plate 503 and the second plate 504 respectively to enable the three dimensional structure 20 to stand and to be exhibited on the cover 10. When the sheet object 511 is placed vertically in the three dimensional structure 20, the sheet object 511 is inserted into the first opening 512 and the second opening 513 for standing stably in the three dimensional structure 20.

When the user desires to collect the sheet object cover 500, he/her can make the sheet object cover 500 in the closing status 515 as shown in FIG. 2, therefore, both collection and exhibition for the sheet object 511 can be achieved easily by the sheet object cover 500.

In summary, the sheet object cover according to the present disclosure can be made of paper sheet, more particularly, the sheet object cover can be completed by two folded paper sheet, so the manufacturing cost can be reduced. Moreover, compared with the technology in the prior art, the sheet object cover according to the present disclosure can exhibit the sheet object by the sheet tension between the three dimensional structure and the cover. When the sheet object cover is opened, the sheet object inside the cover can be exhibited.

The above-mentioned descriptions represent merely the exemplary embodiment of the present disclosure, without any intention to limit the scope of the present disclosure thereto. Various equivalent changes, alternations or modifications based on the claims of present disclosure are all consequently viewed as being embraced by the scope of the present disclosure.

What is claimed is:

1. A sheet object cover, comprising:
a cover, comprising a first plate and a second plate, the cover having an opening status or a closing status; and
a three dimensional structure, comprising a top plate and a bottom plate, and the top plate having a first opening, a first crease and a plurality of first binding layers, and the bottom plate having a second crease and a plurality of second binding layers, and the plurality of first binding layers bound with the first plate and the second plate respectively, and the first opening configured for placing a sheet object, the plurality of second binding layers bound with the first plate and the second plate respectively;
wherein when the cover is in the closing status, the top plate and the bottom plate are folded along the first crease and the second crease to be accommodated inside the cover, so that the sheet object is accommodated inside the cover.

2. The sheet object cover according to claim 1, wherein the first plate and the second plate are formed by doubling up a first folded paper.

3. The sheet object cover according to claim 1, wherein the top plate and the bottom plate are formed by doubling up a second folded paper.

4. The sheet object cover according to claim 2, wherein area of the first plate is just larger than area of the second plate a little, and a side edge of the first plate comprises a folded surface, and the folded surface is inserted into an inserted part of the second plate to fix the closed cover when the cover is closed.

5. The sheet object cover according to claim 1, wherein the bottom plate further comprises a second opening to place the sheet object, and length of the second opening is just shorter than length of the first opening a little.

6. The sheet object cover according to claim 5, wherein the sheet object is inserted into the first opening and the second opening to stand stably in the three dimensional structure.

7. The sheet object cover according to claim 5, wherein the first opening or the second opening comprises a slit opening.

8. The sheet object cover according to claim 1, wherein the sheet object comprises a CD or photograph.

9. The sheet object cover according to claim 1, wherein when the cover is opened, the three dimensional structure enables the sheet object to stand vertically by sheet tension of the first plate and the second plate.
